(19) United States
(12) Patent Application Publication
(10) Pub. No.: US 2024/0351248 A1
(43) Pub. Date: Oct. 24, 2024

(54) MATERIAL AND ARTICLES FORMED FROM REFUSE MATERIALS AND METHODS OF MAKING THE SAME

(71) Applicant: UNIVERSITY OF SOUTH FLORIDA, Tampa, FL (US)

(72) Inventor: John Michael Cotter, Dade City, FL (US)

(21) Appl. No.: 18/640,246

(22) Filed: Apr. 19, 2024

Related U.S. Application Data
(60) Provisional application No. 63/497,309, filed on Apr. 20, 2023.

(51) Int. Cl. B29B 17/02; B29B 7/00; B29B 7/42; B29B 9/16; B29B 17/04; B29K 23/00; B29K 25/00; B29K 27/06; B29K 67/00; B29K 105/26

(52) U.S. Cl. CPC B29B 17/02; B29B 7/007; B29B 7/42; B29B 9/16; B29B 17/0412; B29B 2017/0203; B29B 2017/0224; B29K 2023/06; B29K 2023/12; B29K 2025/06; B29K 2027/06; B29K 2067/003; B29K 2105/26

(57) ABSTRACT

Disclosed herein is a method comprising: providing a refuse collection comprising a first polymer mixture in an amount of greater than 0 wt % to less than 100 wt %, wherein the first polymer mixture comprises a second polymer mixture, wherein the second polymer mixture is about 20 wt % to about 100 wt % of the first polymer mixture and comprises at least one of polyethylene (PE), polypropylene (PP), polystyrene (PS), polyethylene terephthalate (PET), polyvinyl chloride (PVC), or any combination thereof; granulating the first polymer mixture to form a third polymer mixture; and extruding the third polymer mixture to form an article having a strength of about 200 psi to about 5,000 psi.

### CROSS-REFERENCE TO THE RELATED APPLICATIONS

This application is a U.S. nonprovisional utility application, which claims the benefit of priority to U.S. provisional application No. 63/497,309, filed Apr. 20, 2023, the content of which is incorporated herein in its entirety.

### FIELD

The subject matter disclosed herein generally relates to a method for forming an article from a refuse collection comprising a first polymer mixture and a second polymer mixture. Also, the subject matter described herein generally relates to articles made from such methods.

### BACKGROUND

MRF residuals are a specific type of mixed polymers that are essentially a by-product of the plastic recycling industry. MRF residuals result from the recycling process itself. Contrary to typical understanding, plastic recycling is not a process whereby all received materials are recycled in such a way that they can be reused by sending them back to a manufacturing facility. In fact, a large portion of received items are largely ignored from the sorting process. As polymers must be sorted by hand, only high-value polymers are removed by hand, with the remaining smaller pieces of polymer bypassing any selection process and being bailed into an MRF residual bale.

Previously, these polymers were found to have a use as material that could be recycled in locations with relatively lower labor rates. This meant that such bales, due to the low shipping cost, could be sent back to other locations around the Globe and hand-sorted there for positive value. However, some locations and countries have banned the receiving of said items citing health concerns for workers having to deal with the material. The rate at which MRF residuals are recycled is dwindling. The vast majority of MRF residuals recovered within the United States are now either incinerated as a fuel used to generate electricity or simply shipped to a landfill.

Thus, there is a need to utilize and recycle MRF residuals. These needs and others are at least partially satisfied by the present disclosure.

### SUMMARY

In accordance with the purposes of the disclosed materials, compounds, compositions, and methods, as embodied and broadly described herein, the disclosed subject matter, in one aspect, relates to compounds and compositions and methods for preparing and using such compounds and compositions.

In some aspects, disclosed herein is a method comprising: providing a refuse collection comprising a first polymer mixture in an amount of greater than 0 wt % to less than 100 wt %, wherein the first polymer mixture can comprise a second polymer mixture, wherein the second polymer mixture can be about 20 wt % to about 100 wt % of the first polymer mixture and can comprise at least one of polyethylene (PE), polypropylene (PP), polystyrene (PS), polyethylene terephthalate (PET), polyvinyl chloride (PVC), or any combination thereof; granulating the first polymer mixture to form a third polymer mixture; and extruding the third polymer mixture to form an article having a strength of about 200 psi to about 5,000 psi.

In other aspects, provided is an article formed from a refuse collection comprising a first polymer mixture in an amount of greater than 0 wt % to less than 100 wt %, wherein the first polymer mixture can comprise a second polymer mixture, wherein the second polymer mixture can be about 20 wt % to about 100 wt % of the first polymer mixture comprising at least one of polyethylene (PE), polypropylene (PP), polystyrene (PS), polyethylene terephthalate (PET), polyvinyl chloride (PVC), or any combination thereof, wherein the article can have a strength of about 200 psi to about 5,000 psi.

Additional advantages will be set forth in part in the description that follows and in part will be obvious from the description or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 depicts an example process for preparing an article from MRF residuals.

FIG. 2 depicts the results of tension testing articles made from MRF residuals.

FIG. 3 depicts the proposed process. Here, MRF residuals are accepted, double-checked for any large impurities that may have been missed by the MRF, sorted to remove large polymer films, granulated to reduce the size of the materials and provide some mixing, washed of potential contaminates, dried, extruded into a compression mold, and then pressed into a useable product.

FIG. 4 depicts an alternative processing method by which plastic sorting is completely skipped, and all plastics are recycled through the MRFRPP process. This may effectively allow the recycled polymers to accept spare impurities that could not be economically processed while also skipping costly polymer sorting.

FIG. 5 depicts a plot of the normal distribution, the cumulative sum of the normal distribution, along with the histogram of the data for the ultimate tensile strength of all MRF residual samples.

FIG. 6 depicts a plot of the normal distribution, the cumulative sum of the normal distribution, along with the histogram of the data for the ultimate tensile strength of MRF residual samples without impurities artificially inserted into the mixtures.

FIG. 7 depicts the normal distribution, the cumulative normal distribution, and the histogram for the elastic moduli of all samples.

FIG. 8 depicts the normal distribution, the cumulative normal distribution, and the histogram for the elastic moduli of all samples, excluding the PVC-filled samples.

FIG. 9 depicts the average ultimate tensile strength of specimens compared to the extruder set point.

FIG. 10 depicts the samples' thicknesses relative to the processing temperature. The actual mold is 0.160″. Higher processing temperatures prevent improper flow of the molten plastic.

### DETAILED DESCRIPTION

The materials, compounds, compositions, articles, and methods described herein may be understood more readily by reference to the following detailed description of specific aspects of the disclosed subject matter, and the Examples included therein.

Before the present materials, compounds, compositions, kits, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entirety are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

In this specification and in the claims that follow, reference will be made to a number of terms, which shall be defined to have the following meanings:

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The term “or” means “and/or.” Recitation of ranges of values is merely intended to serve as a shorthand method of referring individually to each separate value falling within the range unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context.

All disclosed values also include values that fall within ±10% variation from the disclosed value unless otherwise indicated or inferred. In other words, if a range of 1 to 10 is disclosed, then a range of about 1 to about 10 is disclosed. In such aspects, it is understood that the amount or value in question can be the exact value or a value that provides equivalent results or effects as recited in the claims or taught herein. That is, amounts, sizes, formulations, parameters, and other quantities and characteristics include both exact values but also approximate, larger or smaller values as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘x, y, z, or less’ and should be interpreted to include the specific ranges of ‘x,’ ‘y,’ ‘z,’ ‘about x,’ ‘about y,’ and ‘about z’ as well as the ranges of ‘less than x,’ ‘less than y, or ‘less than z,’ or ‘less than about x,’ ‘less than about y, and ‘less than about z.’ Likewise, the phrase ‘x, y, z, or greater’ should be interpreted to include the specific ranges of ‘x,’ ‘y,’ ‘z,’ ‘about x,’ ‘about y,’ and ‘about z’ as well as the ranges of ‘greater than x,’ greater than y,' ‘greater than z,’ or ‘greater than about x,’ greater than about y,' ‘greater than about z.’ In addition, the phrase “‘x’ to ‘y’,” where ‘x’ and ‘y’ are numerical values, also includes “about ‘x’ to about ‘y’.”

Such a range format is used for convenience and brevity and, thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5% but also include individual values (e.g., 1%, 2%, 3%, and 4%) and the sub-ranges (e.g., 0.5% to 1.1%; 0.5% to 2.4%; 0.5% to 3.2%, and 0.5% to 4.4%, and other possible sub-ranges) within the indicated range.

Recitation of ranges of values herein is merely intended to serve as a shorthand method of referring individually to each separate value recited or falling within the range unless otherwise indicated herein, and each separate value is incorporated into the specification as if it were individually recited. Ranges provided herein are understood to be shorthand for all of the values within the range. For example, a range of 1 to 50 is understood to include any number, or combination of numbers, from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 or sub-ranges from the group consisting of 10-40, 20-50, 5-35, etc. Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, the term “recycled” refers to leftovers of materials that are not in use anymore.

As used herein, the term “composition” is intended to encompass a product comprising the specified ingredients in the specified amounts, as well as any product that results, directly or indirectly, from a combination of the specified ingredients in the specified amounts.

References in the specification and concluding claims to parts by weight of a particular element or component in a composition denote the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition or based on any other calculations as disclosed.

As used herein, the term “substantially,” in, for example, the context “substantially identical” or “substantially similar,” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the terms “substantially identical reference composition” and “substantially identical reference article” refer to a reference composition or article comprising substantially identical components in the absence of an inventive component. In another exemplary aspect, the term “substantially,” in, for example, the context “substantially identical reference composition” or “substantially identical reference article,” refers to a reference composition or an article comprising substantially identical components and wherein an inventive component is absent or is substituted with a common in the art component.

By “contact” or other forms of the word, such as “contacted” or “contacting,” it is meant to add, combine, or mix two or more compounds, compositions, or materials under appropriate conditions to produce a desired product or effect. The term “react” is sometimes used when “contacting” results in a chemical reaction.

While aspects of the present invention can be described and claimed in a particular statutory class, such as the system statutory class, this is for convenience only, and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Methods

Disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while, specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that is possible are specifically contemplated unless specifically indicated to the contrary. Thus, if a class of components A, B, and C are disclosed and a class of components D, E, and F and an example of a combination composition A-D are disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from the disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure, including, but not limited to, steps in methods of making and using the disclosed compositions. Thus, if there are a variety of additional steps that can be performed, it is understood that each of these additional steps can be performed with any specific aspect or combination of aspects of the disclosed methods, and that each such combination is specifically contemplated and should be considered disclosed.

In certain aspects, provided is a method comprising: providing a refuse collection comprising a first polymer mixture in an amount of greater than 0 wt % to less than 100 wt %, wherein the first polymer mixture can comprise a second polymer mixture, wherein the second polymer mixture can be about 20 wt % to about 100 wt % of the first polymer mixture and can comprise at least one of polyethylene (PE), polypropylene (PP), polystyrene (PS), polyethylene terephthalate (PET), polyvinyl chloride (PVC), or any combination thereof; granulating the first polymer mixture to form a third polymer mixture; and extruding the third polymer mixture to form an article having a strength of about 200 psi to about 5,000 psi.

In some aspects, the refuse collection can comprise a first polymer mixture in an amount of greater than 0 wt % to less than 100 wt %, including exemplary values of about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, or about 95 wt %. It is considered that the refuse collection can comprise a first polymer mixture in an amount that falls between any of the disclosed herein values or between any values that can be formed by any of the disclosed herein values. For example, the refuse collection can comprise a first polymer mixture in an amount of from greater than 0 wt % to less than 100 wt %, or from about 5 wt % to about 95 wt %, or from about 10 wt % to about 90 wt %, or from about 15 wt % to about 85 wt %, or from about 20 wt % to about 80 wt %, or from about 25 wt % to about 75 wt %, or from about 30 wt % to about 70 wt %, or from about 35 wt % to about 65 wt %, or from about 40 wt % to about 60 wt %, or from about 45 wt % to about 55 wt %, or from greater than 0 wt % to about 50 wt %, or from about 5 wt % to about 45 wt %, or from about 10 wt % to about 40 wt %, or from about 15 wt % to about 35 wt %, or from about 20 wt % to about 30 wt %, or from about 50 wt % to less than 100 wt %, or from about 55 wt % to about 95 wt %, or from about 60 wt % to about 90 wt %, or from about 65 wt % to about 85 wt %, or from about 70 wt % to about 80 wt %.

In some aspects, the second polymer mixture can be about 20 wt % to about 100 wt % of the first polymer mixture, including exemplary values of about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, or about 95 wt %. It is considered that the second polymer mixture can be an amount of the first polymer mixture that falls between any of the disclosed herein values or between any values that can be formed by any of the disclosed herein values. For example, the second polymer mixture can be from about 20 wt % to about 100 wt % of the first polymer mixture, or from about 25 wt % to about 95 wt %, or from about 30 wt % to about 90 wt %, or from about 35 wt % to about 85 wt %, or from about 40 wt % to about 80 wt %, or from about 45 wt % to about 75 wt %, or from about 50 wt % to about 70 wt %, or from about 55 wt % to about 65 wt %, or from about 20 wt % to about 60 wt %, or from about 25 wt % to about 55 wt %, or from about 30 wt % to about 50 wt %, or from about 35 wt % to about 45 wt %, or from about 60 wt % to about 100 wt %, or from about 65 wt % to about 95 wt %, or from about 70 wt % to about 90 wt %, or from about 75 wt % to about 85 wt %.

In some aspects, the second polymer mixture can comprise about 20 wt % to about 80 wt % polyethylene (PE), about 20 wt % to about 80 wt % polypropylene (PP), about 2 wt % to about 40 wt % of polystyrene (PS), or any combination thereof.

In some such aspects, the second polymer mixture can comprise about 20 wt % to about 80 wt % polyethylene (PE), including exemplary values of about 25 wt %, about 30 wt %, about 35 wt %, about 40 wt %, about 45 wt %, about 50 wt %, about 55 wt %, about 60 wt %, about 65 wt %, about 70 wt %, or about 75 wt %. It is considered that the second polymer mixture can comprise PE in an amount that falls between any of the disclosed values or between any values that can be formed by any of the disclosed values herein. For example, the second polymer mixture can comprise from about 20 wt % to about 80 wt % PE, or from about 25 wt % to about 75 wt %, or from about 30 wt % to about 70 wt %, or from about 35 wt % to about 65 wt %, or from about 40 wt % to about 60 wt %, or from about 20 wt % to about 50 wt %, or from about 25 wt % to about 45 wt %, or from about 30 wt % to about 40 wt %<or from about 50 wt % to about 80 wt %, or from about 55 wt % to about 75 wt %, or from about 60 wt % to about 70 wt %.

In some such aspects, the second polymer mixture can comprise about 20 wt % to about 80 wt % polypropylene (PP), including exemplary values of about 25 wt %, about 30 wt %, about 35 wt %, about 40 wt %, about 45 wt %, about 50 wt %, about 55 wt %, about 60 wt %, about 65 wt %, about 70 wt %, or about 75 wt %. It is considered that the second polymer mixture can comprise PP in an amount that falls between any of the disclosed values or between any values that can be formed by any of the disclosed values herein. For example, the second polymer mixture can comprise from about 20 wt % to about 80 wt % PP, or from about 25 wt % to about 75 wt %, or from about 30 wt % to about 70 wt %, or from about 35 wt % to about 65 wt %, or from about 40 wt % to about 60 wt %, or from about 20 wt % to about 50 wt %, or from about 25 wt % to about 45 wt %, or from about 30 wt % to about 40 wt %, or from about 50 wt % to about 80 wt %, or from about 55 wt % to about 75 wt %, or from about 60 wt % to about 70 wt %.

In some such aspects, the second polymer mixture can comprise about 2 wt % to about 40 wt % of polystyrene (PS), including exemplary values of about 4 wt %, about 6 wt %, about 8 wt %, about 10 wt %, about 12 wt %, about 14 wt %, about 16 wt %, about 18 wt %, about 20 wt %, about 22 wt %, about 24 wt %, about 26 wt %, about 28 wt %, about 30 wt %, about 32 wt %, about 34 wt %, about 36 wt %, or about 38 wt %. It is considered that the second polymer mixture can comprise PS in an amount that falls between any of the disclosed herein values or between any values that can be formed by any of the disclosed herein values. For example, the second polymer mixture can comprise from about 2 wt % to about 40 wt % PS, or from about 4 wt % to about 38 wt %, or from about 6 wt % to about 36 wt %, or from about 8 wt % to about 34 wt %, or from about 10 wt % to about 32 wt %, or from about 12 wt % to about 30 wt %, or from about 14 wt % to about 28 wt %, or from about 16 wt % to about 26 wt %, or from about 18 wt % to about 24 wt %, or from about 20 wt % to about 22 wt %, or from about 2 wt % to about 22 wt %, or from about 4 wt % to about 20 wt %, or from about 6 wt % to about 18 wt %, or from about 8 wt % to about 16 wt %, or from about 10 wt % to about 14 wt %, or from about 20 wt % to about 40 wt %, or from about 22 wt % to about 38 wt %, or from about 24 wt % to about 36 wt %, or from about 26 wt % to about 34 wt %, or from about 28 wt % to about 32 wt %.

In some aspects, the first polymer mixture can further comprise one or more polymers different from the polymers present in the second polymer mixture. In some such aspects, the first polymer mixture can comprise one or more of polyurethane (PU), polymethyl methacrylate (PMMA), polyamide, polycarbonate, styrene, acrylonitrile butadiene styrene, phenol-formaldehyde resin, para-aramid, para-aramid fiber, polychloroprene, meta-aramid polymer, polyacrylonitrile (PAN), copolyamide, polytetrafluoroethylene (PTFE), polyimide, aromatic polyester, poly-p-phenylene-2,6-benzobisoxazole (PBO), polychlorotrifluoroethylene (PCTFE), polysiloxanes, polysilanes, poly (dichlorophosphazene), polyethylene glycol (PEG), Polylactic acid (PLA), cellophane, polycaprolactone (PCL), polilactofate (PLF), polyglycolide (PGA), plastarch material (PSM), polyhydroxybutyrate (PHB), polyepoxides, cyanate esters, urea-formaldehyde, diallyl-phthalate (DAP), melamine formaldehyde, benzoxazines, furan resins, vinyl ester resins, or any combination thereof.

In some aspects, the refuse collection can further comprise waste materials comprising one or more of glass, metals, metal alloys, wood, dirt, rubber, medical waste, textile, paper products, organic material, food waste, electrical components, fibers, post-consumer waste, ceramics, polar liquids, nonpolar liquids, solvents, chemical residues, surfactants, emulsifiers, pesticides, or any combination thereof.

In some aspects, the refuse collection can be a residual collection from a material recycling facility (MRF). In some such aspects, prior to the granulating step, the waste materials greater than 1 inch (e.g., greater than 1.5 inches, greater than 2 inches, greater than 2.5 inches, greater than 3 inches, greater than 3.5 inches, greater than 4 inches, greater than 4.5 inches, greater than 5 inches) can be removed. In other such aspects, prior to the granulating step, the metal and metal alloys having a size greater than 0.05 inch (e.g., greater than 0.1 inch, greater than 0.15 inch, greater than 0.2 inch, greater than 0.25 inch, greater than 0.3 inch, greater than 0.35 inch, greater than 0.4 inch, greater than 0.45 inch, greater than 0.5 inch) can be removed.

In some aspects, the method can further comprise a heat-treating step prior to the granulating step. In some such aspects, the heat-treating step can be a heat-pressing step.

In some aspects, the third polymer mixture, after the granulating step, can have a size of about 0.01 inch to about 0.4 inch, including exemplary values of about 0.02 inch, about 0.03 inch, about 0.04 inch, about 0.05 inch, about 0.1 inch, about 0.15 inch, about 0.2 inch, about 0.25 inch, about 0.3 inch, or about 0.35 inch. It is considered that the third polymer mixture, after the granulating step, can have a size of an amount that falls between any of the disclosed herein values or between any values that can be formed by any of the disclosed herein values. For example, the third polymer mixture, after the granulating step, can have a size of about 0.01 inch to about 0.4 inches, or from about 0.02 inch to about 0.35 inch, or from about 0.03 inch to about 0.3 inches, or from about 0.04 inch to about 0.25 inch, or from about 0.05 inch to about 0.2 inches, or from about 0.1 inches to about 0.15 inch, or from about 0.01 inch to about 0.15 inch, or from about 0.02 inch to about 0.1 inches, or from about 0.03 inch to about 0.05 inch, or from about 0.1 inches to about 0.4 inch, or from about 0.15 inch to about 0.35 inch, or from about 0.2 inch to about 0.3 inch.

In some aspects, the method can further comprise a washing step of the third polymer mixture after the granulating step.

In still further aspects, the methods can also comprise modifying the third polymer mixture prior to the step of forming an article. In such aspects, the modification can include the addition of various additives. For example, the methods can comprise steps of adjusting elastic modulus and/or ultimate tensile strength by additives. The additives can comprise any materials commonly used to arrive at the desired properties. For example, and without limitations, the additives can comprise plasticizers, fillers, anti-aging stabilizers, blowing agents, flame retardants, nucleating agents, processing agents, anti-static agents, colorants, odor agents, anti-microbial agents, and any combinations thereof.

Exemplary and non-limiting fillers that can be added to the third mixture can include calcium carbonate, fly-ash, recycled calcium carbonate, aluminum trihydrate, talc, nano-clay, barium sulfate, barite, barite glass fiber, glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, and any combination thereof. In some aspects, the filler content can be virgin. In other aspects, the filler content can be reclaimed. In certain aspects, the filler content can be reclaimed from post-consumer articles. In yet other aspects, the filler content can be reclaimed from post-industrial articles. In still further aspects, the filler can be formed from MFR materials.

In certain aspects, the filler comprises one or more of calcium carbonate, aluminum trihydrate, barite, feldspar, cullet, fly ash, kaolin clay, limestone, polyurethane foam, rubber, thermoplastic powder, thermoplastic polyurethane (TPU), wollastonite, or any combination thereof.

In yet other aspects, the third polymer mixture can further comprise a pigment, a flame retardant, a surfactant, processing aids, or a combination thereof. In certain aspects, the third polymer mixture can comprise one or more flame-retardant components. Exemplary flame retardants that can be incorporated into the third polymer mixture include, without limitation, organo-phosphorous flame retardants, red phosphorous magnesium hydroxide, magnesium dihydroxide, hexabromocyclododecane, bromine containing flame retardants, brominated aromatic flame retardants, melamine cyanurate, melamine polyphosphate, melamine borate, methylol and its derivatives, silicon dioxide, calcium carbonate, resourcinol bis-(diphenyl phosphate), brominated latex base, antimony trioxide, strontium borate, strontium phosphate, monomeric N-alkoxy hindered amine (NOR HAS), triazine and its derivatives, high aspect ratio talc, phosphated esters, organically modified nanoclays and nanotubes, non-organically modified nanoclays and nanotubes, ammonium polyphosphate, polyphosphoric acid, ammonium salt, triaryl phosphates, isopropylated triphenyl phosphate, phosphate esters, magnesium hydroxide, zinc borate, bentonite (alkaline activated nanoclay and nanotubes), organoclays, aluminum trihydrate (ATH), azodicarbonamide, diazenedicarboxamide, azodicarbonic acid diamide (ADC), triaryl phosphates, isopropylated triphenyl phosphate, triazine derivatives, alkaline activated organoclay and aluminum oxide. Any desired amount of flame retardant can be used in the third polymer mixture, and the selection of such an amount will depend on the required application.

In other aspects, any pigments or surfactants known in the art can be utilized. In yet other aspects, any processing aids known in the art can be used. In some aspects, processing aids can include, without limitation, antistatic chemicals, lubricants, oils, or any combination thereof.

In some aspects, the article can be formed by compression molding.

In some aspects, the article can have a strength of about 200 psi to about 5000 psi, including exemplary values of about 300 psi, about 400 psi, about 500 psi, about 600 psi, about 700 psi, about 800 psi, about 900 psi, about 1000 psi, about 1200 psi, about 1400 psi, about 1600 psi, about 1800 psi, about 2000 psi, about 2500 psi, about 3000 psi, about 3500 psi, about 4000 psi, or about 4500 psi. It is considered that the article can have a strength of an amount that falls between any of the disclosed herein values or between any values that can be formed by any of the disclosed herein values. For example, the article can have a strength of from about 200 psi to about 5000 psi, or from about 300 psi to about 4500 psi, or from about 400 psi to about 4000 psi, or from about 500 psi to about 3500 psi, or from about 600 psi to about 3000 psi, or from about 700 psi to about 2500 psi, or from about 800 psi to about 2000 psi, or from about 900 psi to about 1800 psi, or from about 1000 psi to about 1600 psi, or from about 1200 psi to about 1400 psi, or from about 200 psi to about 1400 psi, or from about 300 psi to about 1200 psi, or from about 400 psi to about 1000 psi, or from about 500 psi to about 900 psi, or from about 600 psi to about 800 psi, or from about 1200 psi to about 5000 psi, or from about 1400 psi to about 4500 psi, or from about 1600 psi to about 4000 psi, or from about 1800 psi to about 3500 psi, or from about 2000 psi to about 3000 psi.

In some aspects, the method can further comprise forming a sheet, a bar, a roll, or a cylinder to form the article. In some such aspects, the article can be a sheet, a bar, a roll, a cylinder, or any combination thereof, and the article can be machinable.

In some aspects, the article can comprise packaging, a structural article, furniture, household goods, organizers, storage devices and containers, conduit, piping, fittings, knobs, handles, tools, insulators, insulation, cladding, seals and gaskets, supports, panels, or any combination thereof.

### Articles

In certain aspects, provided is an article formed from a refuse collection comprising a first polymer mixture in an amount of greater than 0 wt % to less than 100 wt %, wherein the first polymer mixture can comprise a second polymer mixture, wherein the second polymer mixture can be about 20 wt % to about 100 wt % of the first polymer mixture comprising at least one of polyethylene (PE), polypropylene (PP), polystyrene (PS), polyethylene terephthalate (PET), polyvinyl chloride (PVC), or any combination thereof, wherein the article can have a strength of about 200 psi to about 5,000 psi.

In some aspects, the refuse collection can comprise a first polymer mixture in an amount of greater than 0 wt % to less than 100 wt %, including exemplary values of about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, or about 95 wt %. It is considered that the refuse collection can comprise a first polymer mixture in an amount that falls between any of the disclosed herein values or between any values that can be formed by any of the disclosed herein values. For example, the refuse collection can comprise a first polymer mixture in an amount of from greater than 0 wt % to less than 100 wt %, or from about 5 wt % to about 95 wt %, or from about 10 wt % to about 90 wt %, or from about 15 wt % to about 85 wt %, or from about 20 wt % to about 80 wt %, or from about 25 wt % to about 75 wt %, or from about 30 wt % to about 70 wt %, or from about 35 wt % to about 65 wt %, or from about 40 wt % to about 60 wt %, or from about 45 wt % to about 55 wt %, or from greater than 0 wt % to about 50 wt %, or from about 5 wt % to about 45 wt %, or from about 10 wt % to about 40 wt %, or from about 15 wt % to about 35 wt %, or from about 20 wt % to about 30 wt %, or from about 50 wt % to less than 100 wt %, or from about 55 wt % to about 95 wt %, or from about 60 wt % to about 90 wt %, or from about 65 wt % to about 85 wt %, or from about 70 wt % to about 80 wt %.

In some aspects, the second polymer mixture can be about 20 wt % to about 100 wt % of the first polymer mixture, including exemplary values of about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, or about 95 wt %. It is considered that the second polymer mixture can be an amount of the first polymer mixture that falls between any of the disclosed herein values or between any values that can be formed by any of the disclosed herein values. For example, the second polymer mixture can be from about 20 wt % to about 100 wt % of the first polymer mixture, or from about 25 wt % to about 95 wt %, or from about 30 wt % to about 90 wt %, or from about 35 wt % to about 85 wt %, or from about 40 wt % to about 80 wt %, or from about 45 wt % to about 75 wt %, or from about 50 wt % to about 70 wt %, or from about 55 wt % to about 65 wt %, or from about 20 wt % to about 60 wt %, or from about 25 wt % to about 55 wt %, or from about 30 wt % to about 50 wt %, or from about 35 wt % to about 45 wt %, or from about 60 wt % to about 100 wt %, or from about 65 wt % to about 95 wt %, or from about 70 wt % to about 90 wt %, or from about 75 wt % to about 85 wt %.

In some aspects, the article can have a strength of about 200 psi to about 5000 psi, including exemplary values of about 300 psi, about 400 psi, about 500 psi, about 600 psi, about 700 psi, about 800 psi, about 900 psi, about 1000 psi, about 1200 psi, about 1400 psi, about 1600 psi, about 1800 psi, about 2000 psi, about 2500 psi, about 3000 psi, about 3500 psi, about 4000 psi, or about 4500 psi. It is considered that the article can have a strength of an amount that falls between any of the disclosed herein values or between any values that can be formed by any of the disclosed herein values. For example, the article can have a strength of from about 200 psi to about 5000 psi, or from about 300 psi to about 4500 psi, or from about 400 psi to about 4000 psi, or from about 500 psi to about 3500 psi, or from about 600 psi to about 3000 psi, or from about 700 psi to about 2500 psi, or from about 800 psi to about 2000 psi, or from about 900 psi to about 1800 psi, or from about 1000 psi to about 1600 psi, or from about 1200 psi to about 1400 psi, or from about 200 psi to about 1400 psi, or from about 300 psi to about 1200 psi, or from about 400 psi to about 1000 psi, or from about 500 psi to about 900 psi, or from about 600 psi to about 800 psi, or from about 1200 psi to about 5000 psi, or from about 1400 psi to about 4500 psi, or from about 1600 psi to about 4000 psi, or from about 1800 psi to about 3500 psi, or from about 2000 psi to about 3000 psi. In some aspects, the article can have a strength of about 1000 to about 2000 psi.

In some aspects, the article can comprise packaging, a structural article, furniture, household goods, organizers, storage devices and containers, conduit, piping, fittings, knobs, handles, tools, insulators, insulation, cladding, seals and gaskets, supports, panels, or any combination thereof.

### EXAMPLES

The following examples are set forth below to illustrate the methods and results according to the disclosed subject matter. These examples are not intended to be inclusive of all aspects of the subject matter disclosed herein but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, the temperature is in ° C. or is at ambient temperature, and pressure is at or near atmospheric. There are numerous variations and combinations of reaction conditions, e.g., component concentrations, temperatures, pressures, and other reaction ranges and conditions, which can be used to optimize the product purity and yield obtained from the described process. Only reasonable and routine experimentation will be required to optimize such process conditions.

### Example 1

MRF residuals are a byproduct from the recycling industry that is a growing percentage of output from recycling centers. Approximately 8% of all plastics are recycled, while 50% of plastics received at recycling facilities are actually recycled. In other words, 16% of plastics that are touched by consumers are placed in recycling bins and sent to recycling facilities. Of this 16%, half of the plastic received is recycled, and the other half is deemed MRF Residuals.

MRF Residuals have little value due to the cost required to sort recycled material (and likely negative value as the material must be disposed of), the material is largely either incinerated as a fuel for energy generation or shipped to landfills.

The economic breakdown is as follows:
1) Recycling Plastic costs approximately $80 per ton.
2) Recycled Plastic sells for approximately $200-400 per ton, depending on the market rates.
3) MRF Residuals are also sold for approximately $40 per ton.

Most MRF residuals are either sold to be burned as fuel or sent to landfills.

These MRF Residuals, despite their noted minimal value, have value as a structural material due to the low cost associated with the material. Accordingly, a series of experiments were designed and tested to measure the mechanical strength of such mixtures of polymers. These polymer mixtures represent a highly heterogeneous mixture that limits the strength of the resulting material to less than that of typical polymers. However, the low cost allows for the economic recovery of value from these products.

One method by which to increase the rate of recycling of products within the United States is to develop uses of such materials that give them positive economic value. If recycling facilities are required to operate at a net cost, their implementation may be more limited as the enforcement of recycling is inherently difficult. However, by providing a means by which said materials have a positive value as they can be recycled significantly more easily, this means that eventually, if the value increase is great enough, individuals may work to recycle the material for sale as is done currently with metals (i.e., if polymers were recycled as aluminum is and cash could be paid to individuals recycling the products, recycling rates may greatly increase while providing useful products).

The largest question here is how to make such a system possible. This is accomplished by first establishing some guidelines that can eventually be developed into a method of manufacture using these low-value materials.

### Background

It is proposed and shown that these materials may have a value far exceeding the energy generation of the material if these materials are reprocessed into a low-quality structural material.

Disclosed herein is a method by which MRF residual mixtures are tested for their mechanical strength. This method can yield a multi-material composite polymer intended as a low-cost material created directly from MRF residuals.

### Mechanical Strength

Without wishing to be bound by any theory, it is hypothesized that within any material, be it steel, aluminum, plastic, or lumber, the mechanical strength varies. The variability has been incorporated into the design strengths of materials, and grades are created. For example, individual plates constructed of A36 steel will have varied strength, albeit the strength will not have a large variability. Also, steel-graded A36 will be much weaker than steel-graded A58.

Wood is the greatest material to compare to this polymer regarding variability. While grades of lumber do exist, which do give different material strength, these grades result from visible conditions assumed to vary the strength. This process works acceptably well for wood as a material as it sees widespread use.

Without wishing to be bound by any theory, it is hypothesized that the plastics that result from random mixtures of polymers may have mechanical strength within ranges. But this mechanical strength may have a greater value than the most common, weak plastic available. For example, molded low-density polyethylene has a minimum ultimate tensile strength of 406 psi, an average ultimate tensile strength of 1,566 psi, a minimum Young's modulus of 13.1 ksi, and an average Young's modulus of 31.8 ksi (from Matweb). As shown below, these values are lower than what typically results from the polymers made by the disclosed methods.

As is done in numerous other industries, the mechanical strength can be determined by forming a prototype article from a batch composition prepared by the disclosed methods and testing the article's strength properties at the testing facilities. Random samples can be used to easily determine the mechanical properties of the batch composition.

Additional properties that can be modified by the creation of such heterogeneous polymer composites are aligned with the following:

Melt Index: The melt flow index of the polymer may be modified and may result in a value that may not be acceptable for high-end polymer articles but can be used for low-cost articles with applications in industries where such properties are acceptable.

Melting Point: Another issue that arises is the melting point of the different polymers. While this issue is prevalent, it seems to have no significant, detrimental effect on the strength of samples manufactured and tested.

### Manufacturing Process

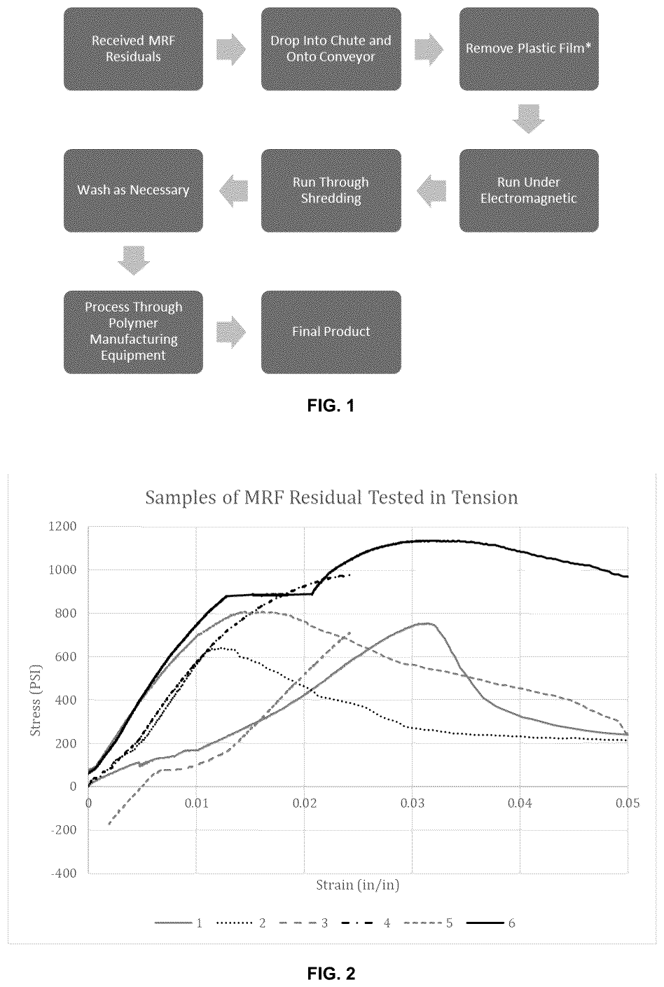

Preparing the Product or Production Overview: The disclosed methods significantly reduce or completely bypass the need for costly sorting processes associated with the recovery of the economic value of polymers. Accordingly, the process for production is simplistic as shown in FIG. 1.

Specific Manufacturing Processes: Several specific manufacturing processes have been identified, though it is highly likely that others can be used.

Compression Molding: Compression molding is unique in that it can allow for a much wider range of potential melt flow indexes anticipated to be encountered. As long as the operation is tuned during processing by modifying the force of compression and the speed of compression, this material can be manufactured into economical parts due to the extremely low cost of the material.

### Potential End Uses

There are numerous suggested end uses of such a material. Examples include compositing with steel as well as polymer products where the friable nature is of little consequence.

Packaging: Packaging may be one of the best possible uses of the material. The packaging industry is very large and poses significant potential market size. For example, the cardboard box industry in the United States is estimated to have a market size of $80B. This industry has likely increased in value due in part to the prevalence of packaging used for products shipped from online stores.

The polymer samples developed have proven to be potentially used as a low-cost alternative to cardboard boxes while maintaining similar strengths and some advantages, such as significantly improved water resistance.

Packaging Manufacturing Process: The process by which packaging can be manufactured is by compression molding two sheets with a support pattern, then gluing or heating and pressing the supporting elements together. Doing so would allow for the manufacture of a structure that features two sheets with support ridges (e.g., rectilinear support ridges, honeycomb support ridges, etc.) holding the two sheets together.

### Experimentation

Sourcing the Materials: Due to the limitations of recycled polymers, the actual MRF residuals can be difficult to source. Most MRF residuals are incinerated as fuel. Instead of sourcing MRF residuals directly, resins of the various polymers were purchased, excluding polyvinyl chloride (PVC), which is not commonly available in resin form. Instead, PVC was sourced from leftover PVC pipe from other projects. The PVC was shredded using a small leaf chipper. It represents only 1% of the polymer used, so its potential effect on the strength is limited. The other resins were obtained from eBay. They were mixed by hand in a large container. The specific combinations used were determined to be similar to one disclosed by A. Adrados et al. and are known to be present in MRF materials.

Manufacturing Test Samples: The polymer mixture was heated in a testing drum.

First, a small amount of melted polymer was pulled from the drum and then placed in the mold and pressed together. The mold was then water-cooled, and the mold was removed. Water can be sprayed between the part and mold, allowing for easier separation.

Test Results for Tension Tests: The test results improved with later samples. The strengths can be seen in FIG. 2.

### Example 2

The following study explores the manufacturing process, including the steps and properties of recycled materials at each step.

### Recycling Process Flows

Recycling process flows vary per MRF (material recycling facility). However, all tend to have residuals that consist of materials that could not be effectively sorted at the facility. Whether indicated or not, all MRFs will produce residuals. These residuals are dealt with by various methods, including incineration for energy, shipping to countries with lower labor rates for sorting (this process is occurring less frequently due to some countries' ban on these materials) and sending them to landfills.

New processes are in development. These include pyrolysis and new sorting methods. The disclosed approach establishes manufacturing methods that can directly use this material.

### Processing Method According to One Aspect of This Disclosure

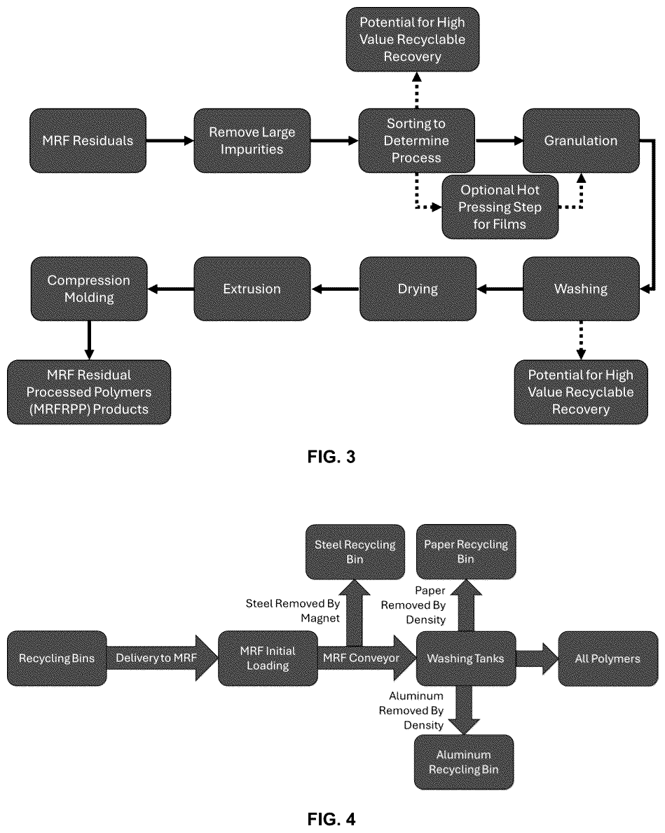

The disclosed processing method is shown in FIG. 3. Below, each step is reviewed, including the equipment used for that step and the components of the MRF residual mix.

MRF Residuals: MRF Residuals have varied composition, inherently. The intention, due to other materials received at MRFs having higher value, is that MRF Residuals primarily include polymers (e.g., cardboard and paper received by an MRF are typically recycled through other means, though some of these impurities can exist in MRF residuals). These MRF residuals include polymers of various types, which are the intended reprocessed material, as well as impurities.

The intended materials for reprocessing are packaging polymers, which can include, but are not limited to, high density polyethylene (HDPE), polypropylene (PP), polystyrene (PS), expanded polystyrene (PS), polyethylene terephthalate (PET), low-density polyethylene (LDPE), polyvinyl chloride (PVC), polyethylene film, and polypropylene film. However, many other polymers may become part of the aggregate mix. The primary components of the mix would be the most common polymers found in packaging, which can include, but are not limited to, polyethylene (PE, independent of density), polypropylene (PP), and polystyrene (PS). Polyvinyl chloride (including CPVC) and polyethylene terephthalate generally exist in packaging in lower quantities, on average.

In some aspects, the polymer mix can make up about 20-100% of the total mixture. The impurities can make up about 0-80% of the mixture. In some aspects, the mixture of polymers can include at least 3 polymers of the following list, in the percentage of 1% to 99%, independent of the initial manufacturing method, and as rigid or film: polyethylene (PE, independent of density), polypropylene (PP), polystyrene (PS), polyvinyl chloride (PVC), polyethylene terephthalate (PET). Other polymers can optionally contribute to this mix.

In some aspects, the polymer mix can include about 20-80% polyethylene, about 20-80% propylene, and about 2.0-40% polystyrene.

Impurities (which can make up 0-80% of the product) can include but are not limited to, Complex, Blister, Tetra-Brik, Al film, aluminum, iron, ABS, PMMA, PUR, PA, PC, elastomer, latex, medical waste, paper, clothes, gardening, wood, glass, and other recycled materials that are of unknown origin.

MRF residuals may also be supplied in various sizes, dependent on the sorting of the specific facility. For example, some facilities may not remove polyethylene or polypropylene films from the MRF residuals. Other facilities may have no mechanism for the removal of paper products. Other facilities may purposefully avoid sorting glass.

Percentages of each component can be referenced from the random samples of A. López et al., “Pyrolysis of municipal plastic wastes: Influence of raw material composition,” Waste Management, vol. 30, no. 4, pp. 620-627, 2010.

Despite these MRF residual compositions, a blended MRF residual that maintains the composition requirements can have a resulting product strength, after processing, of 200-5000 psi.

Remove Large Impurities: This step can be completed by the MRF, as these large impurities commonly have economic value. Examples include large pieces of steel (>0.0625″, accomplished by an electromagnet or other techniques), large pieces of aluminum (>1.00″ if foil, the most common aluminum source, and accomplished by eddy current or other techniques), glass (>2.00″ pieces of glass bottles), paper and cardboard (>3.00″), etc. Larger pieces of these impurities may reduce the operational efficiency of the equipment of the processes described herein; however, it is hypothesized that the granulator may allow for fairly large components of impurities, except for steel that can be easily removed by an electromagnet. This step can be accomplished by an operator via inspection over a conveyor belt or with a continuously running electromagnet (the electromagnet is standard in many industries).

Sorting to Determine Process: If possible, larger plastic films that may clog the granulator can be separated into an additional optional stream. These plastic films are commonly >6″×6″ pieces but are dependent on the granulator and granulator screen. Larger films can be manually separated (removed from the conveyor belt by hand). Yet, in other examples, the flow can be diverted to a bin for Heat Pressing. This step can be performed while on the same conveyor belt as listed above.

Optional Heat Pressing Step: A pretreatment process may be necessary, which may be required if too many plastic films are present. This process can be accomplished in many ways, with one of those methods being heating the polymer mixture to 350-400° F. then pressing it into a thickened sheet by hydraulics, pneumatics, flywheels, or other actuation methods. The thickness of this sheet is dependent on the granulator used. The granulator can process heated and pressed plastic films that are up to 1 inch thick after pressing.

Granulation: The granulator used in this disclosure is a 2.2 KW, 220V single-phase granulator designed for polymers. The screen has an aperture of 0.236″ (6 mm) and a processing capacity of 110-220 lbs/hr (50-100 kg/hr). The maximum product feed size is 3.74″×3.74″ (95 mm×95 mm). Larger granulators can be fed larger rigid plastic components or heat-pressed polymer sheets for granulation.

Following granulation, the MRF residual particle size is reduced to below 0.236″, with the largest particles having a single dimension this size, many particles having an approximate diameter of 0.190″, many particles having a diameter of 0.030″, and still plastic dust can result, which are particles even smaller. In fact, it may prove to be more economical and safer to provide a dust collector for these small particles so that they can be collected and reprocessed without risking being inhaled by workers. This dust collector can be connected via a fume hood over the granulator and can pull a vacuum inside the granulator. The dust particles can then collect inside the dust collector, and the dust can be fed back into the process so as not to lose this material, as it is safest to be recombined into a thickened polymer after processing.

A larger screen may be appropriate for the granulator if using a larger extruder than the current study. For example, a larger and longer extruder may provide adequate mixing if only granulating down to a size of 0.354″ (9 mm). This would result in a different granulated particle size, which would have to be used inside the granulator.

Regardless of maximum dimensions, most granulated plastic particles are much thinner than their other dimensions, as the plastic containers from which they are derived are commonly manufactured to have these small thicknesses. For example, many of the samples have thicknesses of 0.010″ to 0.030″, though plastics with greater thicknesses than this can result from processing through the granulator.

As mentioned previously, plastic films may be granulated if converted to a hot-pressed film of appropriate thickness. This may be required as too large of a plastic film fed into a granulator can result in clogging of the granulator.

Washing: In this process, all the recycled plastics were washed prior to granulation. However, given the condition of most recycled materials, the washing phase may occur after the granulation phase. This may be required as many residues are contained within a larger plastic item that is to be processed. This process helps to eliminate potential contamination from food particles as well as remove potentially harmful chemicals.

Contamination from food may prove to be less of a concern due to the high processing temperatures. For example, the polymers during processing may reach temperatures far exceeding the requirements for killing bacteria. Water is boiled to kill harmful bacteria (212° F.) while the polymers are processed at 386° F. or similar temperatures, far exceeding the temperature commonly used to kill bacteria.

This process can occur in a larger tank with agitation or a wet conveyor with water sprays.

Drying: Drying can be accomplished through several mechanisms, including fluidized bed dryers, rotary dryers, rolling bed dryers, etc. This step helps to prevent water from entering the extruder, which may cause process upsets or reduced process temperatures.

As the samples were pre-washed and set to dry for several days, this process was not necessary in the current pilot study.

Extrusion: After drying, the polymers can then be fed directly to an extruder. The extruder used is a hand-built desktop extruder that uses the extruder screw and barrel from a Precious Plastics Extrusion Pro. These extruders are essentially a kit that requires some modification to fit to equipment available in the United States. The gearbox is a 25:1, NEMA 56C, right-angle, worm drive gearbox with a rating of 1750 RPM and 1,784 in-lbs. The extrusion screw is a 1.18″ (30 mm) diameter with a feed zone, a compression zone, and a metering zone. The inner diameter of the barrel is approximately 1.18″ (30 mm), while the outer diameter of the barrel is 1.97 inches (50 mm).

This extruder functions primarily to heat and mix the polymers and impurities. The heating band controllers were set to 386° F. during operation. The motor is driven by a VFD set to 45 Hz frequency (75% motor speed). The motor is a 3-phase, 60 Hz, 220V, 56C/TEFC, 2 HP, 1725 RPM, Inverter Duty motor. The VFD is a 220V, 2.2 kW, 10 A VFD with single-phase input and 3-phase output. Three 1000 W heating bands are used on the screw, controlled by two PIDs and two thermocouples.

Compression Molding: The compression mold was custom-machined from 6061 aluminum. The end mill used was a 3-flute, 3-degree taper, ¼″ by 2¼″ long. The mold results in a final sample shape of 2.30″ width, 0.160″ thickness, and 7.50″ length. The thickness between samples can vary due to the variable melt flow index and difference in shot sizes. Compression was applied using a manual, 20-ton shop press.

MRF Residual Products: A primary product of the MRFRPP (MRF Residual Processed Polymers) can be packaging. These include: cups, cartons, cans, tins, tubes, bottles, boxes, pouches, sachets, pallets, supports, interior supports, inserts, bins, lids, packs, bags, packets, tubs, baskets, canisters, cases, crates, receptacles, sacks, cribbing, dunnage, cages, pens, packs, trunks, totes, containers, buckets, capsules, jugs, jars, pails, pots, tanks, vials, vessels, casks, caskets, chests, crocks, flasks, hampers, hoppers, vats, blocks, wrappers, etc. These items can be primary packaging, secondary packaging, tertiary packaging, quaternary packaging, etc.

Reinforcement of MRFRPP may be possible, such as through the inclusion of reinforcement wire, glass, ceramics, fibers, etc., which could increase the potential applications.

Structural components may be produced from MRFRPP, whether reinforced or not. Structural components such as beams, columns, girders, joists, pipes, spouts, launderers, channels, molding, formwork, furniture, bases, stands, boards, decking, etc. may be produced.

### Processing Alternatives

Many of the proposed processes can be modified as appropriate. Modifications may be necessary as different MRFs have different processes and the quality of byproducts produced. Some of the key alternatives may be in the granulation, washing, drying, extrusion, or compression molding process.

Granulation: A shredder, a related and similar machine, may prove to be better for generating a feedstock of MRF residuals of sufficiently small size to be fed into the extruder or other mixing device.

Washing: Washing may be modified by incorporating density separation. For example, many plastics float, however, saturated cardboard tends to sink, as well as aluminum, glass, and iron. A separate subprocess to gravity separate these materials may be appropriate. Additionally, if sufficient quantities of high-value products are located in these streams, reprocessing this material may be appropriate.

Drying and Extrusion: These can be combined as it may be appropriate to combine these processes into a single unit by tumbling and heating the polymers to the desired temperatures. An alternative system may be a batch system that heats and mixes the mass, similar to a kneading process.

Compression Molding: An alternative method to compression molding is rolling. The polymers tested thus far appear to be capable of rolling, which could allow for the production of MRFRPP sheets, bars, and other shapes.

This can be paired with reinforcement methods.

### Future Processing Methods

If the MRFRPP method is found to be successful, it can be implemented for all polymers intended for recycling. That is, it may be economically and environmentally beneficial to process all polymers intended to be recycled as an aggregate mass. See FIG. 4 for an example.

This method could be economically beneficial as it is typical that sorting of recycled materials increases the cost of recycled goods to a cost that is higher than virgin polymers. Conversely, if all polymers were combined into a single feedstock for reprocessing into low-cost packaging, the processing cost of the polymers could be greatly decreased due to the elimination of the high-cost processing methods.

The specific reason commonly cited for the high cost of processing recycled polymers is that many recycled plastic products are not of substantial quality and quantity. For example, most often, only the largest of plastic items (approximately the size of a one-gallon jug) are sorted and reprocessed. Smaller items, such as cups designed to contain 8 fluid ounces or less, are not recycled. Sorting to remove steel, aluminum, and cardboard can be more cost-effective due to the greater difference in properties of these materials as compared to all plastics.

While plastics are often labeled with recycling symbols that correlate with the specific plastic the item is made of, most of these items cannot actually be recycled by traditional methods due to numerous reasons, including those plastics being a film. Despite two plastic items being marked as a “5,” which indicates polypropylene, those two items may not be compatible as different grades of polymers exist within each type of polymer. For example, one item may have been extruded, which requires a lower melt-flow index (a measure of the viscosity of a polymer when heated), while the other may have been injection molded, which requires a higher melt-flow index.

However, by processing large quantities of MRF residuals, the strength of randomly selected polymer compositions can have a strength that typically averages to the average plastic strength of 1500-2000 psi. This means that while carefully sorting may result in a superior product, the additional cost of sorting may not be worth the value it provides. It is possible, therefore, that simply processing all recycled polymers as an aggregate mass may be a superior method as this method may provide a superior strength-to-cost (including processing costs) ratio, though this is not the only design metric used as strength-to-density is also an important consideration.

### Example 3

Machining can occur in many ways. For example, an article made from the polymer mixture formed herein can be turned on a lathe. A lathe allows a wide array of different procedures for creating the workpiece into a useful part. A lathe can be used to turn the outside diameter of the article into a smaller diameter (if the article isn't completely round, the lathe can turn it into a perfect cylinder, +/−0.001″). A lathe can also be used to bore the inside of a cylinder of this material. A drill bit was used for this, which cuts a hole into the article. A boring bar can also be used for larger interior dimensions.

The inside of the hollow cylinder can also be tapped using a tap, optionally by hand. This is a tool that looks like a screw or bolt that is used to cut threads inside a workpiece. Then, exterior threaded parts can be threaded into that part. Threading of plastic for piping is practiced in industry on the interior and/or exterior of pipes. The plastic, after pressing, can be drilled and threaded. A screw supporting weight (about 0.2 lbs) on a 4-40 machine screw can then be screwed into the plastic article.

The article can be machined before or after compression, molding, or rolling. To create a round shape, a compression mold with a cylindrical interior shape (e.g., either a vertically oriented cone or a horizontal cylinder) could be used. To make it more cylindrical, in both cases, it could be machined round, but the tolerances would depend on the specific object being constructed.

To form a sheet, a set of rollers underneath the output of the extruder can be turned to press the material into a sheet, round bar, or other shapes. The article can be pressed using a batch process to a specific size, whereas rolling the article would be a continuous process.

It was also found that the disclosed herein polymers can be fused together using heating applied at a joint, then squeezing them together. For added strength, the surface of the joint was modified such that the molten plastic was moved from one side to the other. This process was repeated on each side, resulting in a joint. The strength of the joins can be improved by heating two pieces and pressing them together in a factory setting. This would increase the number of potential applications of this material.

### Example 4

A study was conducted to explore the statistically relevant information regarding the ultimate tensile strength and elastic modulus of the MRF residual polymers processed by compression molding and using a desktop extruder. The results indicate that the design ultimate tensile strength of the MRF residuals could be 975 psi (average of 1190 psi), having a coefficient of variation of 0.127. Note that this is similar to steel, which has a coefficient of variation of 0.11 for ultimate tensile failure (T. V. Galambos and M. Ravindra, “Load and resistance factor design,” Engineering Journal, AISC, vol. 18, no. 3, pp. 78-84, 1981). Additionally, the elastic modulus average was 77 ksi with a coefficient of variation of 0.180.

### Tensile Strength

### Tensile Strength Data

After significantly more testing, statistics have been developed for the MRF residual plastics. Table 1 shows the samples tested for ultimate tensile strength using the method described in ASTM-D638-TYPE-1. Note that all samples were cut using a scroll saw, but due to imperfections in this process, all samples were measured for width and thickness. Also note that the samples at the top of the chart labeled HDPE resin, polypropylene resin, and polystyrene resin were included to indicate the typical polymer strengths that would result from more pure samples of polymer. The thickness is noteworthy as this deviates from ASTM-D638.

TABLE 1
The first six samples are control specimens to test the manufacturing
method. The samples labeled MRFR (Material Recycling Facility Residuals) are
random samples of polymer mixtures that are sourced from recycled plastic items.
Sample notes are necessary as there are various contaminates and MRFR stocks
that were used. The samples were taken sequentially to verify that testing was
replicable between testing runs.

| | | Sample | Sample | | Ultimate |
|---|---|---|---|---|---|
| Sample | | Width | Thickness | Area | Tensile |
| Name | Sample Notes | (in) | (in) | (in²) | Strength (psi) |
| 6.5-0-0.1 | HDPE Resin | 0.481 | 0.162 | 0.078 | 2631 |
| 6.5-0-0.2 | HDPE Resin | 0.47 | 0.15 | 0.071 | 2937 |
| 0-6.5-0.2 | Polypropylene Resin | 0.514 | 0.172 | 0.088 | 2034 |
| 0-0-6.5.1 | Polystyrene Resin | 0.494 | 0.189 | 0.093 | 2018 |
| 0-0-6.5.2 | Polystyrene Resin | 0.521 | 0.191 | 0.100 | 1809 |
| MRFR-1.1 | MRFR Stock #1 | 0.495 | 0.183 | 0.091 | 1334 |
| MRFR-1.2 | MRFR Stock #1 | 0.483 | 0.18 | 0.087 | 945 |
| MRFR-2.1 | MRFR Stock #1, but shredded | 0.499 | 0.187 | 0.093 | 1205 |
| | to a smaller size | | | | |
| MRFR-2.2 | MRFR Stock #1, but shredded | 0.518 | 0.178 | 0.092 | 1164 |
| | to a smaller size | | | | |
| MRFR-3.1 | MRFR Stock #2, with added | 0.514 | 0.196 | 0.101 | 1171 |
| | 25% PVC | | | | |
| MRFR-3.2 | MRFR Stock #2, with added | 0.505 | 0.198 | 0.100 | 1042 |
| | 25% PVC | | | | |
| MRFR-4.1 | MRFR Stock #2, with added | 0.49 | 0.201 | 0.098 | 904 |
| | 25% PVC | | | | |
| MRFR-4.2 | MRFR Stock #2, with added | 0.511 | 0.196 | 0.100 | 1122 |
| | 25% PVC | | | | |
| MRFR-5.1 | MRFR Stock #3 | 0.512 | 0.2 | 0.102 | 1169 |
| MRFR-5.2 | MRFR Stock #3 | 0.518 | 0.201 | 0.104 | 1191 |
| MRFR-6.1 | MRFR Stock #1 | 0.49 | 0.175 | 0.086 | 1086 |
| MRFR-6.2 | MRFR Stock #1 | 0.489 | 0.168 | 0.082 | 825 |
| MRFR-7.1 | MRFR Stock #1 | 0.492 | 0.179 | 0.088 | 1277 |
| MRFR-7.2 | MRFR Stock #1 | 0.493 | 0.184 | 0.091 | 1147 |
| MRFR-8.1 | MRFR Stock #1, mixed 50/50 | 0.512 | 0.203 | 0.104 | 905 |
| | by volume with shredded | | | | |
| | Styrofoam | | | | |
| MRFR-8.2 | MRFR Stock #1, mixed 50/50 | 0.508 | 0.189 | 0.096 | 958 |
| | by volume with shredded | | | | |
| | Styrofoam | | | | |
| MRFR-9.1 | MRFR Stock #1, with 5% sand | 0.506 | 0.221 | 0.112 | 1270 |
| | by volume | | | | |
| MRFR-9.2 | MRFR Stock #1, with 5% sand | 0.461 | 0.205 | 0.095 | 1356 |
| | by volume | | | | |
| MRFR-10.1 | MRFR Stock #1, mixed 50/50 | 0.502 | 0.196 | 0.098 | 1563 |
| | with polystyrene resin | | | | |
| MRFR-10.2 | MRFR Stock #1, mixed 50/50 | 0.48 | 0.197 | 0.095 | 1639 |
| | with polystyrene resin | | | | |
| MRFR-11.1 | MRFR Stock #1, mixed 50/50 | 0.48 | 0.192 | 0.092 | 1047 |
| | with polystyrene resin | | | | |
| MRFR-11.2 | MRFR Stock #1, mixed 50/50 | 0.48 | 0.193 | 0.093 | 1190 |
| | with polystyrene resin | | | | |
| MRFR-12.1 | MRFR Stock #4 | 0.493 | 0.198 | 0.098 | 1196 |
| MRFR-12.2 | MRFR Stock #5 | 0.486 | 0.198 | 0.096 | 1091 |
| MRFR-13.1 | MRFR Stock #1 | 0.532 | 0.175 | 0.093 | 1235 |
| MRFR-13.2 | MRFR Stock #1 | 0.493 | 0.1845 | 0.091 | 1294 |
| MRFR-14.1 | MRFR Stock #1, mixed with | 0.502 | 0.182 | 0.091 | 1721 |
| | 3% aluminum foil by mass | | | | |
| MRFR-14.2 | MRFR Stock #1, mixed with | 0.513 | 0.18 | 0.092 | 1267 |
| | 3% aluminum foil by mass | | | | |

### Tensile Strength Statistical Analysis

This study took two primary approaches to reviewing this data. The entire dataset was considered using the assumption that MRF residual mixtures will include impurities that cannot always be controlled for. This approach was used first. The subsequent section only looks at “clean” samples, which were defined as samples that were mixtures of polymers sourced randomly from recycled plastic and without known contaminates (e.g., minimal contaminates or no contaminates artificially inserted into the material).

All Samples Including Artificially Contaminated Samples—Ultimate Tensile Strength: Looking at the reduced dataset, the properties of the resulting samples are shown in Table 2 below.

TABLE 2
The MRFR samples and ultimate tensile strengths.

| Sample Name | Ultimate Tensile Strength (psi) |
|---|---|
| MRFR-1.1 | 1334 |
| MRFR-1.2 | 945 |
| MRFR-2.1 | 1205 |
| MRFR-2.2 | 1164 |
| MRFR-3.1 | 1171 |
| MRFR-3.2 | 1042 |
| MRFR-4.1 | 904 |
| MRFR-4.2 | 1122 |
| MRFR-5.1 | 1169 |
| MRFR-5.2 | 1191 |
| MRFR-6.1 | 1086 |
| MRFR-6.2 | 825 |
| MRFR-7.1 | 1277 |
| MRFR-7.2 | 1147 |
| MRFR-8.1 | 905 |
| MRFR-8.2 | 958 |
| MRFR-9.1 | 1270 |
| MRFR-9.2 | 1356 |
| MRFR-10.1 | 1563 |
| MRFR-10.2 | 1639 |
| MRFR-11.1 | 1047 |
| MRFR-11.2 | 1190 |
| MRFR-12.1 | 1196 |
| MRFR-12.2 | 1091 |
| MRFR-13.1 | 1235 |
| MRFR-13.2 | 1294 |
| MRFR-14.1 | 1721 |
| MRFR-14.2 | 1267 |

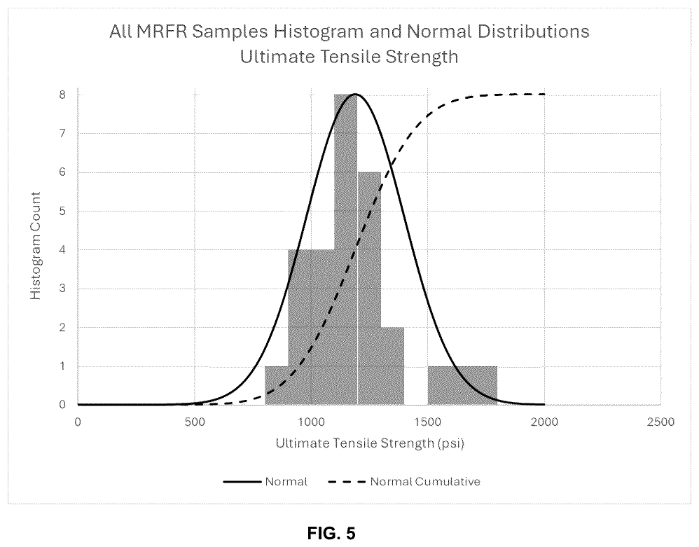

Next, the average and standard deviation were calculated and plotted with the resulting histogram for the MRFR samples in Table 2. This plot is shown in FIG. 5.

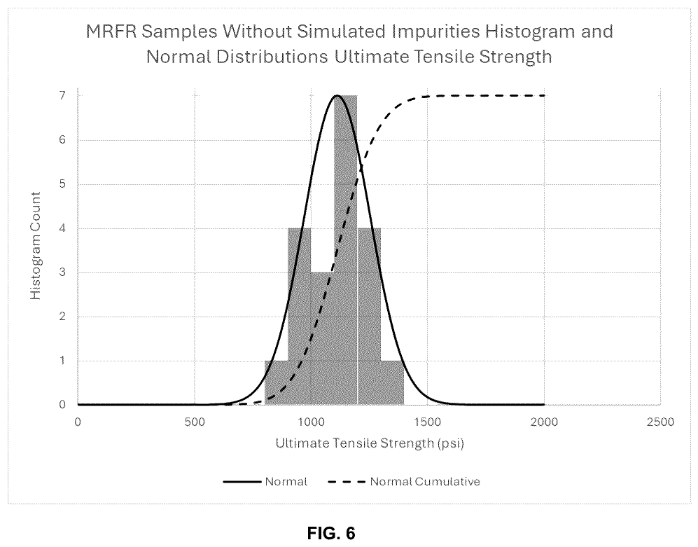

Despite the use of dissimilar polymers, the resulting aggregate or composite polymer composed of MRF residuals contained a lower than typical average, but the variance of the material was low enough that a design strength can be selected that allows for direct use of the material. This includes when random contaminates were incorporated into the polymer mixtures. Clean Samples Ultimate Tensile Strength: The study also considered “clean” samples. This refers to eliminating samples that have had their strengths modified by the inclusion of artificial impurities. Table 3 below shows the samples specifically included in this dataset. FIG. 6 is a plot of the resulting histogram and normal distributions.

TABLE 3
The remaining samples after removing those with impurities.

| Sample Name | Ultimate Tensile Strength (psi) |
|---|---|
| MRFR-0.1 | 1235 |
| MRFR-0.2 | 1294 |
| MRFR-1.1 | 1334 |
| MRFR-1.2 | 945 |
| MRFR-2.1 | 1205 |
| MRFR-2.2 | 1164 |
| MRFR-3.1 | 1171 |
| MRFR-3.2 | 1042 |
| MRFR-4.1 | 904 |
| MRFR-4.2 | 1122 |
| MRFR-5.1 | 1169 |
| MRFR-5.2 | 1191 |
| MRFR-6.1 | 1086 |
| MRFR-6.2 | 825 |
| MRFR-7.1 | 1277 |
| MRFR-7.2 | 1147 |
| MRFR-8.1 | 905 |
| MRFR-8.2 | 958 |
| MRFR-12.1 | 1196 |
| MRFR-12.2 | 1091 |

Of particular note is that the normal distribution was narrower in FIG. 6, as compared to the greater variability of FIG. 5. This means that random contaminates did increase the variability of the MRF residual polymer mixtures after processing.

### Tensile Strength Results

Table 4 shows the average ultimate tensile strength, its standard deviation, and its coefficient of variance when considering all MRF residual samples and only the “clean” samples.

TABLE 4
The comparison of the ultimate tensile strength average,
standard deviation, and coefficient of
variation for the artificially contaminated
samples and the “clean” samples.

| | All MRF | Only |
|---|---|---|
| | Residual | “Clean” |
| | Samples | Samples |
| Average Ultimate Tensile Strength (psi) | 1190 | 1113 |
| Standard Deviation of Ultimate Tensile | 209 | 142 |
| Strength (psi) | | |
| Coefficient of Variation Ultimate Tensile | 0.176 | 0.128 |
| Strength | | |

What is noteworthy in Table 4 is that while the average ultimate tensile strength did decrease when considering only “clean” samples, the standard deviation also decreased. In fact, the standard deviation decreased comparatively more. This is indicated by the coefficient of variation difference between the sample sets. In other words, and as seen in FIG. 5, many outliers caused by contamination were on the higher-strength side of the distribution. This was a frequent occurrence with the MRF residual samples; while a normal distribution appeared to result, there remained outliers on the higher value side more often than the lower value side. Design for engineering applications most often focuses on the minimum anticipated values as dictated by statistics.

For example, when considering Limit State Design (LSD) or Load and Resistance Factor Design (LRFD), resistance factors were used to reduce the strength of considered elements. However, as the samples tended to have high outliers instead of low, it may be more appropriate to increase the design load or resistance factor to capture more capacity in the material. This is heavily dependent on the statistics, individual feedstocks, and the individual process.

As further examples, some MRFs may produce a higher quantity of contaminants than others. This may be dependent on the ability of the MRF to remove contaminates. This would mean that some MRF residuals may have statistical values that appear more similar to the “clean” samples of Table 4, while others may appear more similar to the “all” samples if their MRF residuals contain more aluminum, glass, paper, etc.

Design strength depends on how it is defined in a particular industry. It is commonly referenced relative to the average, standard deviation, coefficient of variation, etc., of the material. Following in the example provided by T. V. Galambos et al., it can be suggested that the design strength is defined approximately as one standard deviation below the average strength value when considering ultimate tensile strengths in steel. If this approach is applied to the MRF residual plastic samples, the resulting design strengths would be 981 psi when considering all samples and 971 psi when considering clean samples only. These values are close enough that a substantial distinction is likely not necessary. However, the resistance factor would likely need to be lower for the more variable MRF residual plastics. Additionally, since the primary intended use of this MRF residual material is for packaging, it likely would not be held to as high a standard as materials designed to support structures due to the great risk to human life seen in structures. In other words, direct use of the resistance factors from structural steel may be inaccurate, dependent on the use or application of the MRF residual materials.

### Elastic (Young's) Modulus

The study also investigated the elastic modulus of the MRF residual samples. This is relevant as many designs are dictated by the elastic modulus, particularly when buckling is a consideration.

### Elastic Modulus Data

Samples used to determine the strength of the MRF residual polymer composites could not be directly used to calculate the elastic modulus of the materials. This was due to not having the necessary measurement tool to determine the strain that occurs across the reduced cross-section of an ASTM-D638 sample. Therefore, a different set of samples were fabricated in which the samples had a uniform cross-section. While the study did indicate the failure stress due to the connecting mechanisms used in the universal testing machine, these samples failed prematurely at the clamping point. The maximum stresses were used, however, to calculate the elastic modulus by taking reference points at ⅓ and ⅔ of the maximum stress and calculating the slope between these points (which is equivalent to the elastic modulus). This section was used as it eliminates inaccuracies that may develop when considering lower stress values. Note that these samples were not used to calculate the ultimate tensile strength in the sections preceding this section.

TABLE 5
The elastic modulus samples are shown along with their maximum stress
and strains at various positions. To eliminate potential issues
with the calibration of the samples, the elastic modulus was calculated
from ⅓ the ultimate tensile strength to ⅔
the ultimate tensile strength, with the difference in strain
considered. E is the elastic modulus of the material.

| | | | Strain | | Strain | | |
|---|---|---|---|---|---|---|---|
| | Maximum | ⅓ | @ ⅓ | ⅔ | @ ⅔ | Delta | |
| Sample | Stress | Stress | Stress | Stress | Stress | Strain | E |
| Name | (psi) | (psi) | (in/in) | (psi) | (in/in) | (in/in) | (ksi) |
| MRFR-1.y | 885 | 295 | 0.0099 | 590 | 0.0137 | 0.00380 | 78 |
| MRFR-2.y | 928 | 309 | 0.0106 | 619 | 0.0145 | 0.00385 | 80 |
| MRFR-3.y | 1331 | 444 | 0.0102 | 887 | 0.0147 | 0.00450 | 98 |
| MRFR-4.y | 948 | 316 | 0.0053 | 632 | 0.0077 | 0.00237 | 134 |
| MRFR-5.y | 900 | 300 | 0.0041 | 600 | 0.0060 | 0.00190 | 158 |
| MRFR-6.y | 974 | 325 | 0.0105 | 649 | 0.0146 | 0.00413 | 79 |
| MRFR-7.y | 1287 | 429 | 0.0132 | 858 | 0.0206 | 0.00746 | 57 |
| MRFR-8.y | 556 | 185 | 0.0103 | 371 | 0.0138 | 0.00344 | 54 |
| MRFR-9.y | 1020 | 340 | 0.0070 | 680 | 0.0112 | 0.00428 | 79 |
| MRFR- | 760 | 253 | 0.0084 | 507 | 0.0113 | 0.00289 | 88 |
| 10.y | | | | | | | |
| MRFR- | 1218 | 406 | 0.0114 | 812 | 0.0180 | 0.00654 | 62 |
| 11.y | | | | | | | |
| MRFR- | 841 | 280 | 0.0107 | 561 | 0.0153 | 0.00464 | 60 |
| 12.y | | | | | | | |
| MRFR- | 952 | 317 | 0.0086 | 634 | 0.0121 | 0.00347 | 91 |
| 13.y | | | | | | | |
| MRFR- | 1189 | 396 | 0.0114 | 793 | 0.0162 | 0.00479 | 83 |
| 14.y | | | | | | | |

### Elastic Modulus Statistical Analysis

Next, the study performed statistical analysis for the elastic modulus of the samples.

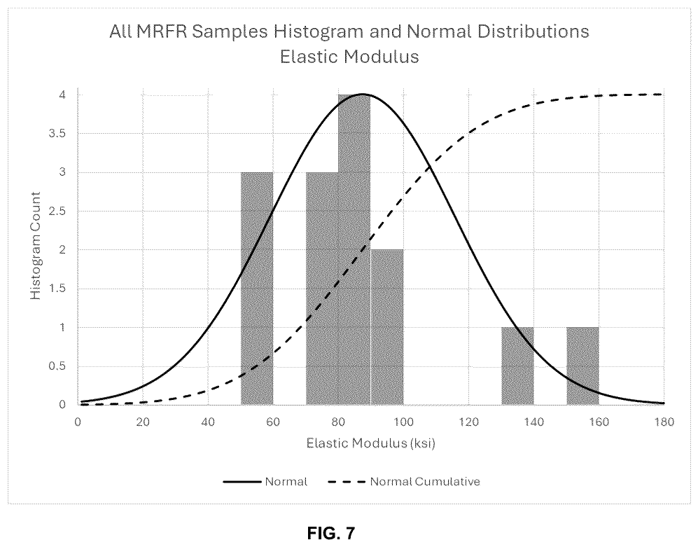

All Samples Including Artificially Contaminated Samples—Elastic Modulus: For this consideration, no values from Table 5 were eliminated. FIG. 7 indicates that two outliers exist which have significantly higher elastic moduli. The outliers are at the 134 and 158 ksi values for the elastic modulus. These were the samples that included a high percentage of PVC. These were removed in the following section.

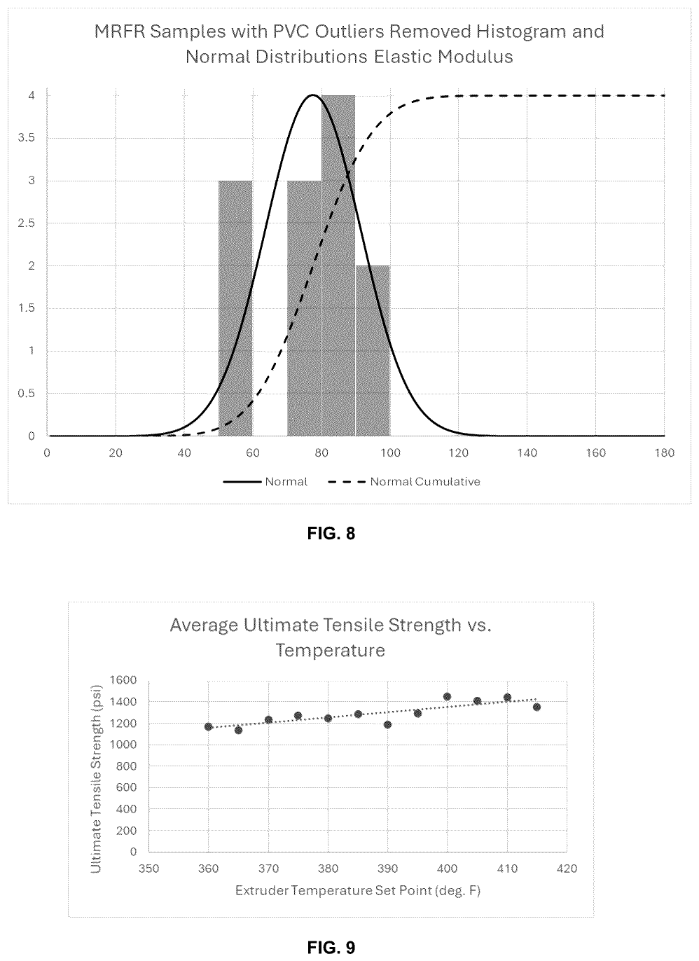

PVC Outliers Removed—Elastic Modulus: Next, the study reran the statistical analysis, this time eliminating the high PVC content outliers. The samples considered are shown in Table 6. The results are shown in FIG. 8. As can be seen, the distribution was much narrower than in FIG. 7.

TABLE 6
The elastic moduli of the samples once
the outliers (which are samples that
include a high infill of PVC) are removed.

| Sample Name | E (ksi) |
|---|---|
| MRFR-1.y | 78 |
| MRFR-2.y | 80 |
| MRFR-3.y | 98 |
| MRFR-6.y | 79 |
| MRFR-7.y | 57 |
| MRFR-8.y | 54 |
| MRFR-9.y | 79 |
| MRFR-10.y | 88 |
| MRFR-11.y | 62 |
| MRFR-12.y | 60 |
| MRFR-13.y | 91 |
| MRFR-14.y | 83 |

### Elastic Modulus Results

The results of the statistical analysis, comparing the groups “all” and “without PVC” samples datasets, are shown in Table 7 below.

TABLE 7
The comparison of the elastic modulus average, standard deviation,
and coefficient of variation for all samples and the sample
set with the PVC-containing samples was removed.

| | All MRF Residual | PVC Samples |
|---|---|---|
| | Samples | Removed |
| Average Elastic Modulus (ksi) | 87.3 | 77.5 |
| Standard Deviation of Elastic | 28.4 | 13.9 |
| Modulus (ksi) | | |
| Coefficient of Variation Elastic | 0.325 | 0.180 |
| Modulus | | |

### Discussion

Despite the wide variety of polymers in the feedstock materials, random MRF residual plastics, when processed by polymer extrusion (for mixing and heating) followed by compression molding, resulted in sufficient mixing of the polymers to allow for a composite of dissimilar polymers that had sufficient strength for practical usage, including when considering the variability of the strength of the material.

For example, while the lowest typical strength for a low-density polyethylene is commonly 1450 psi (10 MPa), due to the high relative cost of pure polymers, MRF residual plastics, when mixed sufficiently produced a material with a design ultimate tensile strength of 975 psi. However, as MRF residual polymers are deemed by many MRFs as having no value or representing a net cost due to needing to dispose of this material, the material cost of these MRF residuals could be suggested to be only the cost to ship the materials. This means in some cases, dependent on the manufacturing cost, MRF residual polymers may serve as a lower cost substitute.

Additionally, it may be possible to further increase the strength of the resulting MRF residual polymer mixture by increasing the mixing of the composite material. Some samples suggested that increasing the mixing of the polymers may result in a further increase in the strength of the material.

It is noted that some of the polymers used may have been processed at a lower than ideal temperature. The temperature was set to 386° F., but there may be a better setting that allows for superior blending of polymers, which may increase the resulting strength of the polymer composite composed of the MRF residual mixtures.

### Example 5

The last manufacturing method (the other two being compression molding and rolling) that may work for the MRF residuals is extrusion molding (molding). In this process, a mold is attached to the end of the extruder. Then, the extruder is run so as to discharge into the mold attached to the end of the extruder. This allows for making some additional parts without necessarily requiring compression molding.

Once removed from the mold, the polymer composite material can be used directly as a part or machined, as discussed previously.

### Example 6

A study was conducted that measured the strength of the MRF residual composite polymers with respect to changing the process temperature of the extruder. By modifying the process temperature, the resulting average strength of the MRF residual composite polymers increased. There are multiple explanations for this:
1) The polymers commonly used in consumer products and packaging have varied melting and processing temperatures. The melting temperatures are shown in Table 8 below.
2) Reduction in potential “skin effects.” The cooling of the exterior of the plastic prior to compression molding is referred to as the polymer composite developing a skin of cooled plastic that prevents sufficient mixing of the polymer at the exterior. Once molded, this skin will be incorporated into the part, creating a weakened section.

TABLE 8
The different melting temperatures for the different
plastics encountered in MRF residuals
(note that other polymers are included in this table
and may be included in random
MRF residuals, though likely in very low quantities).

| | MELT | | MELT | |
|---|---|---|---|---|
| | TEMPERATURE | | TEMPERATURE | |
| | RANGE (° C.) | | RANGE (° F.) | |
| MATERIAL | MIN | MAX | MIN | MAX |
| ABS | 190 | 270 | 374 | 518 |
| ABS/POLYCARBONATE | 245 | 265 | 473 | 509 |
| ALLOY | | | | |
| ACETAL | 180 | 210 | 356 | 410 |
| ACRYLIC | 220 | 250 | 428 | 482 |
| CAB | 170 | 240 | 338 | 464 |
| HDPE* | 210 | 270 | 410 | 518 |
| LDPE* | 180 | 240 | 356 | 464 |
| NYLON 6 | 230 | 290 | 446 | 554 |
| NYLON 6 (30% GF) | 250 | 290 | 482 | 554 |
| NYLON 6/6 | 270 | 300 | 518 | 572 |
| NYLON 6/6 (33% GF) | 280 | 300 | 536 | 572 |
| NYLON 11 | 220 | 250 | 428 | 482 |
| NYLON 12 | 190 | 200 | 374 | 392 |
| PEEK | 350 | 390 | 662 | 734 |
| POLYCARBONATE | 280 | 320 | 536 | 608 |
| POLYESTER PBT* | 240 | 275 | 464 | 527 |
| PET (SEMI-CRYSTALLINE)* | 260 | 280 | 500 | 536 |
| PET (AMORPHOUS)* | 260 | 280 | 500 | 536 |
| POLYPROPYLENE | 200 | 280 | 392 | 536 |
| (COPOLYMER)* | | | | |
| POLYPROPYLENE | 200 | 280 | 392 | 536 |
| (HOMOPOLYMER)* | | | | |
| POLYPROPYLENE (30% | 240 | 290 | 464 | 554 |
| TALC-FILLED) | | | | |
| POLYPROPYLENE (30% GF) | 250 | 290 | 482 | 554 |
| POLYSTYRENE* | 170 | 280 | 338 | 536 |
| POLYSTYRENE (30% GF) | 250 | 290 | 482 | 554 |
| PVC P* | 170 | 190 | 338 | 374 |
| PVC U* | 160 | 210 | 320 | 410 |
| SAN | 200 | 260 | 392 | 500 |
| SAN (30% GF) | 250 | 270 | 482 | 518 |
| TPE | 260 | 320 | 500 | 608 |

*indicates the more common polymers.

It is likely that the lower processing temperatures were not completely allowing the polymers to mix. The significance of increasing the temperature is shown in FIG. 9. The figure compares the values of the ultimate tensile strength of samples made of random plastic samples to show that as the process temperatures increased, the average strength of samples increased. This increased ultimate tensile strength is noteworthy as the increased strength can allow MRF residual composites to be used in a wider variety of applications.

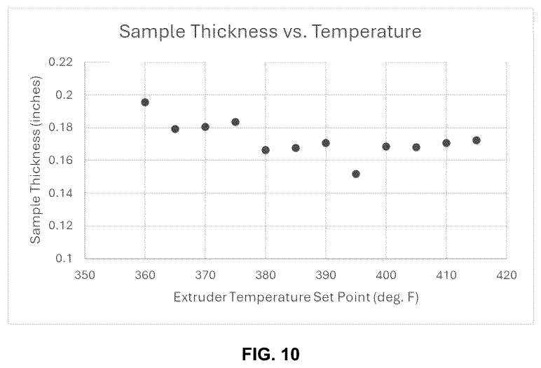

The study also compared the sample thickness with the process temperature. This is shown in FIG. 10. The thickness more closely matched the actual thickness of 0.160″ when the process temperature increased due to the molten plastic flowing more easily inside the mold.

It is noted that the process temperature, which was defined as the temperature setting of the extruder, does not directly reflect the actual polymer temperature. As the polymer is squeezed inside the extruder, the temperature of the polymer composite mixture is often higher than the setting of the extruder. The polymer does cool on the surface, as mentioned before, which causes issues when manufacturing samples.

### EXEMPLARY ASPECTS

In view of the described processes and compositions, hereinbelow are described certain more particularly described aspects of the disclosures. These particularly recited aspects should not, however, be interpreted to have any limiting effect on any different claims containing different or more general teachings described herein or that the “particular” aspects are somehow limited in some way other than the inherent meanings of the composites and formulas literally used therein.

Example 1: A method comprising: providing a refuse collection comprising a first polymer mixture in an amount of greater than 0 wt % to less than 100 wt %, wherein the first polymer mixture comprises a second polymer mixture, wherein the second polymer mixture is about 20 wt % to about 100 wt % of the first polymer mixture and comprises at least one of polyethylene (PE), polypropylene (PP), polystyrene (PS), polyethylene terephthalate (PET), polyvinyl chloride (PVC), or any combination thereof; granulating the first polymer mixture to form a third polymer mixture; and extruding the third polymer mixture to form an article having a strength of about 200 psi to about 5,000 psi.

Example 2: The method of any examples herein, particularly example 1, wherein the second polymer mixture comprises about 20 wt % to about 80 wt % polyethylene (PE), about 20 wt % to about 80 wt % polypropylene (PP), about 2 wt % to about 40 wt % of polystyrene (PS), or any combination thereof.

Example 3: The method of any examples herein, particularly example 1, wherein the first polymer mixture further comprises one or more polymers different from the polymers present in the second polymer mixture.

Example 4: The method of any examples herein, particularly example 3, wherein the first polymer mixture comprises one or more of polyurethane (PU), polymethyl methacrylate (PMMA), polyamide, polycarbonate, styrene, acrylonitrile butadiene styrene, phenol-formaldehyde resin, para-aramid, para-aramid fiber, polychloroprene, meta-aramid polymer, polyacrylonitrile (PAN), copolyamide, polytetrafluoroethylene (PTFE), polyimide, aromatic polyester, poly-p-phenylene-2,6-benzobisoxazole (PBO), polychlorotrifluoroethylene (PCTFE), polysiloxanes, polysilanes, poly (dichlorophosphazene), polyethylene glycol (PEG), Polylactic acid (PLA), cellophane, polycaprolactone (PCL), polilactofate (PLF), polyglycolide (PGA), plastarch material (PSM), polyhydroxybutyrate (PHB), polyepoxides, cyanate esters, urea-formaldehyde, diallyl-phthalate (DAP), melamine formaldehyde, benzoxazines, furan resins, vinyl ester resins, or any combination thereof.

Example 5: The method of any examples herein, particularly example 1, wherein the refuse collection further comprises waste materials comprising one or more of glass, metals, metal alloys, wood, dirt, rubber, medical waste, textile, paper products, organic material, food waste, electrical components, fibers, post-consumer waste, ceramics, polar liquids, nonpolar liquids, solvents, chemical residues, surfactants, emulsifiers, pesticides, or any combination thereof.

Example 6: The method of any examples herein, particularly example 1, wherein the refuse collection is a residual collection from a material recycling facility (MRF).

Example 7: The method of any examples herein, particularly example 5, wherein prior to the granulating step, the waste materials greater than 1 inch are removed.

Example 8: The method of any examples herein, particularly example 5, wherein prior to the granulating step, the metal and metal alloys having a size greater than 0.05 inch are removed.

Example 9: The method of any examples herein, particularly example 1, further comprising a heat-treating step prior to the granulating step.

Example 10: The method of any examples herein, particularly example 9, wherein the heat-treating step is a heat-pressing step.

Example 11: The method of any examples herein, particularly example 1, wherein the third polymer mixture after the granulating step, has a size of about 0.01 inch to about 0.4 inch.

Example 12: The method of any examples herein, particularly example 1, further comprises a washing step of the third polymer mixture after the granulating step.

Example 13: The method of any examples herein, particularly example 1, wherein the article is formed by compression molding.

Example 14: The method of any examples herein, particularly example 1, wherein the article has a strength of about 800 psi to about 2000 psi.

Example 15: The method of any examples herein, particularly example 1, further comprising forming a sheet, a bar, a roll, or a cylinder to form the article.

Example 16: The method of any examples herein, particularly example 15, wherein the article is a sheet, a bar, a roll, a cylinder, or any combination thereof, and wherein the article is machinable.

Example 17: The method of any examples herein, particularly example 1, wherein the article comprises a packaging, a structural article, furniture, household goods, organizers, storage devices and containers, conduit, piping, fittings, knobs, handles, tools, insulators, insulation, cladding, seals and gaskets, supports, panels, or any combination thereof.

Example 18: An article formed from a refuse collection comprising a first polymer mixture in an amount of greater than 0 wt % to less than 100 wt %, wherein the first polymer mixture comprises a second polymer mixture, wherein the second polymer mixture is about 20 wt % to about 100 wt % of the first polymer mixture comprising at least one of polyethylene (PE), polypropylene (PP), polystyrene (PS), polyethylene terephthalate (PET), polyvinyl chloride (PVC), or any combination thereof, wherein the article has a strength of about 200 psi to about 5,000 psi.

Example 19: The article of any examples herein, particularly example 18, wherein the article has a strength of about 1000 to about 2000 psi.

Example 20: The article of any examples herein, particularly example 18, wherein the article comprises a packaging, a structural article, furniture, household goods, organizers, storage devices and containers, conduit, piping, fittings, knobs, handles, tools, insulators, insulation, cladding, seals and gaskets, supports, panels, or any combination thereof.

What is claimed is:

1. A method comprising:
providing a refuse collection comprising a first polymer mixture in an amount of greater than 0 wt % to less than 100 wt %, wherein the first polymer mixture comprises a second polymer mixture, wherein the second polymer mixture is about 20 wt % to about 100 wt % of the first polymer mixture and comprises at least one of polyethylene (PE), polypropylene (PP), polystyrene (PS), polyethylene terephthalate (PET), polyvinyl chloride (PVC), or any combination thereof;
granulating the first polymer mixture to form a third polymer mixture; and
extruding the third polymer mixture to form an article having a strength of about 200 psi to about 5,000 psi.

2. The method of claim 1, wherein the second polymer mixture comprises about 20 wt % to about 80 wt % polyethylene (PE), about 20 wt % to about 80 wt % polypropylene (PP), about 2 wt % to about 40 wt % of polystyrene (PS), or any combination thereof.

3. The method of claim 1, wherein the first polymer mixture further comprises one or more polymers different from the polymers present in the second polymer mixture.

4. The method of claim 3, wherein the first polymer mixture comprises one or more of polyurethane (PU), polymethyl methacrylate (PMMA), polyamide, polycarbonate, styrene, acrylonitrile butadiene styrene, phenol-formaldehyde resin, para-aramid, para-aramid fiber, polychloroprene, meta-aramid polymer, polyacrylonitrile (PAN), copolyamide, polytetrafluoroethylene (PTFE), polyimide, aromatic polyester, poly-p-phenylene-2,6-benzobisoxazole (PBO), polychlorotrifluoroethylene (PCTFE), polysiloxanes, polysilanes, poly (dichlorophosphazene), polyethylene glycol (PEG), Polylactic acid (PLA), cellophane, polycaprolactone (PCL), polilactofate (PLF), polyglycolide (PGA), plastarch material (PSM), polyhydroxybutyrate (PHB), polyepoxides, cyanate esters, urea-formaldehyde, diallyl-phthalate (DAP), melamine formaldehyde, benzoxazines, furan resins, vinyl ester resins, or any combination thereof.

5. The method of claim 1, wherein the refuse collection further comprises waste materials comprising one or more of glass, metals, metal alloys, wood, dirt, rubber, medical waste, textile, paper products, organic material, food waste, electrical components, fibers, post-consumer waste, ceramics, polar liquids, nonpolar liquids, solvents, chemical residues, surfactants, emulsifiers, pesticides, or any combination thereof.

6. The method of claim 1, wherein the refuse collection is a residual collection from a material recycling facility (MRF).

7. The method of claim 5, wherein prior to the granulating step, the waste materials greater than 1 inch are removed.

8. The method of claim 5, wherein prior to the granulating step, the metal and metal alloys having a size greater than 0.05 inch are removed.

9. The method of claim 1, further comprising a heat-treating step prior to the granulating step.

10. The method of claim 9, wherein the heat-treating step is a heat-pressing step.

11. The method of claim 1, wherein the third polymer mixture after the granulating step, has a size of about 0.01 inch to about 0.4 inch.

12. The method of claim 1, further comprises a washing step of the third polymer mixture after the granulating step.

13. The method of claim 1, wherein the article is formed by compression molding.

14. The method of claim 1, wherein the article has a strength of about 800 psi to about 2000 psi.

15. The method of claim 1, further comprising forming a sheet, a bar, a roll, or a cylinder to form the article.

16. The method of claim 15, wherein the article is a sheet, a bar, a roll, a cylinder, or any combination thereof, and wherein the article is machinable.

17. The method of claim 1, wherein the article comprises packaging, a structural article, furniture, household goods, organizers, storage devices and containers, conduit, piping, fittings, knobs, handles, tools, insulators, insulation, cladding, seals and gaskets, supports, panels, or any combination thereof.

18. An article formed from a refuse collection comprising a first polymer mixture in an amount of greater than 0 wt % to less than 100 wt %, wherein the first polymer mixture comprises a second polymer mixture, wherein the second polymer mixture is about 20 wt % to about 100 wt % of the first polymer mixture comprising at least one of polyethylene (PE), polypropylene (PP), polystyrene (PS), polyethylene terephthalate (PET), polyvinyl chloride (PVC), or any combination thereof, wherein the article has a strength of about 200 psi to about 5,000 psi.

19. The article of claim 18, wherein the article has a strength of about 1000 to about 2000 psi.

20. The article of claim 18, wherein the article comprises a packaging, a structural article, furniture, household goods, organizers, storage devices and containers, conduit, piping, fittings, knobs, handles, tools, insulators, insulation, cladding, seals and gaskets, supports, panels, or any combination thereof.
